(19) United States
(12) Patent Application Publication
(10) Pub. No.: US 2011/0274923 A1
(43) Pub. Date: Nov. 10, 2011

(54) EXTRUSION SYSTEM COMPRISING A BACK PRESSURE CONTROLLING BRAKE DEVICE

(75) Inventors: Markus Hartmann, Sendenhorst (DE); Rainer Goering, Borken (DE); Andreas Weinmann, Blieskastel (DE); Sascha Kottmann, Riedisheim (FR)

(73) Assignee: EVONIK DEGUSSA GMBH, Essen (DE)

(21) Appl. No.: 13/143,351

(22) PCT Filed: Jan. 18, 2010
(86) PCT No.: PCT/EP10/50509

§ 371 Date: Jul. 6, 2011

(30) Foreign Application Priority Data
Jan. 20, 2009 (DE) 10 2009 005 523.1
Jul. 9, 2009 (DE) 10 2009 032 287.6

(51) Int. Cl. D02G 3/00; B29C 47/90

(52) U.S. Cl. 428/364; 425/66

(57) ABSTRACT

The invention relates to an extrusion system for producing cylindrical semi-finished plastic products. The extrusion system comprises an extruder (1) for making available a pressurized plastic melt, at least one extrusion die (7) arranged on the extruder (1) and allowing the melt to leave the extruder (1) as a substantially cylindrical plastic strand (8), a calibration unit (2) which is mounted downstream of the extrusion die (7) and through which the freshly extruded plastic strand (8) passes, said calibration unit cooling the plastic strand (8) and giving it an outer diameter (d), a brake device (3) mounted downstream of the calibration unit (2) and adapted to introduce a variable axial force (A) into the plastic strand (8), said axial force being opposite to the advance of the plastic strand, and a force transducer (9) measuring the axial force (A) introduced into the plastic strand (8) by the brake device (3). The aim of the invention is to improve said extrusion system in such a manner that a better standard quality can be obtained and that it is suitable for the processing of high-temperature resisting plastics. For this purpose, the brake device (3) comprises at least one brake block (16) having a friction surface (19) which brake block is guided so as to be radially movable relative to the plastic strand (8). A radial force (R) is applied to the radially movably guided brake block (16) with its friction surface (19) resting on the periphery of the plastic strand (8) to introduce the axial force (A) into the plastic strand (8). The friction surface (19) has the shape of a grooved section of the surface area of a cylinder.

The invention relates to an extrusion system for producing cylindrical semi-finished plastic products according to the preamble of claim 1.

Such an extrusion system is known from WO 1998/09709 A1.

Metallic components are increasingly being replaced with components made of high-performance plastics in lightweight structural applications in air and space travel, in machine tools and textile machines and also in automotive engineering. In this respect, mention should be made in particular of heat-resistant and high-performance thermoplastics such as polyether ether ketone (PEEK).

From the user's point of view, the production of components made of polyether ether ketone rather resembles conventional metal processing: standardized semi-finished products such as pipes, profiles or rods are brought to size in the desired shape by machining. In the case of PEEK, the direct production of ready-to-use components by means of an injection molding machine, such as for PP or PE components, is unusual. The semi-finished products alone are produced in accordance with the conventional production of plastics: thus, profiles, pipes or solid rods are likewise fundamentally extruded on an extrusion system, as is usual for the production of corresponding semi-finished products made of PP or PE.

WO 1998/09709 A1 describes an extrusion system suitable for the production of cylindrical semi-finished products made of thermoplastic, polyolefin-based bulk plastics. Said system comprises a heated screw extruder, known per se, which melts the plastic fed in in granule form. The melt leaves through an extrusion die, and the latter provides the continuous strand produced with its coarse cross section. In a downstream calibration section, the strand of plastic is cooled and provided with the desired outer dimension. A brake device comprising two polyurethane rollers rolling on the freshly calibrated strand is arranged downstream of the calibration unit. The rollers are pressed against the strand by a spring-loaded lever system in order to allow cleaner rolling. The rollers, which are mounted rotatably in the levers, are provided with a pneumatic brake (not described in more detail). This makes it possible to decelerate the rollers on their respective axes of rotation and to thereby introduce an axial force directed counter to the advance of the strand of plastic into said strand of plastic. This axial force increases the back pressure in the portion of the strand between the extrusion die and the brake device and thereby ensures particularly high material density in the extrudate. The axial force is measured using a force transducer and guided into a control device. Depending on the measured axial force, this produces a brake force in the brake device. The axial force is thereby controlled.

A first disadvantage of this extrusion system is the sluggish and inaccurate control of the axial force: for example, the axial force is measured via a flexurally stressed element so that the axial force has to be calculated from the deflection of the bending element. Secondly, the brake force transmission path from the rotating roller brake into the strand forms a long dead section, which has a negative effect on the speed and the accuracy of the control.

A further disadvantage of the known extrusion system is that it is not suitable for processing plastics having a high melting point: polyolefins such as PP and PE are extruded at about 200° C., the temperature of the strand of plastic after it has passed through the cooling calibration unit still being about 32 to 60° C. (90 to 140° F.). At these low temperatures, the PU wheels of the brake device still run on the strand without sticking. However, PEEK is a high-temperature-resistant thermoplastic, the melt of which leaves the extrusion die at about 400° C. After the calibration, the temperature of the PEEK is still much higher than 100° C., and therefore in the known system it would be necessary to ensure that the PU wheels of the brake device thereof do not withstand the thermal and mechanical load and damage the strand of plastic.

In the light of this prior art, the invention is based on the object of developing an extrusion system of the type mentioned in the introduction such that it achieves a better quality of control and is suitable for processing high-temperature-resistant plastics.

This object is achieved by an extrusion system as claimed in claim 1.

The invention therefore relates to an extrusion system for producing cylindrical semi-finished plastic products, comprising an extruder for providing a pressurized melt of the plastic, comprising at least one extrusion die which is arranged on the extruder and through which the melt leaves the extruder as a substantially cylindrical strand of plastic, comprising a calibration unit which is arranged downstream of the extrusion die and through which the freshly extruded strand of plastic passes, said calibration unit cooling the strand of plastic and giving it an outer diameter, comprising a brake device which is arranged downstream of the calibration unit and which makes it possible to variably introduce an axial force into the strand of plastic, the axial force being directed opposite to the advance of the latter, and comprising a force transducer which measures the axial force introduced into the strand of plastic by the brake device, wherein the brake device comprises at least one brake block which is movably guided radially relative to the strand of plastic and is provided with a friction surface, wherein a radial force can be applied to the radially movably guided brake block when the friction surface thereof rests on the periphery of the strand of plastic in order to introduce the axial force into the strand of plastic, and wherein the friction surface has the shape of a groove-like section of a cylinder casing.

The radially movable brake block configured according to the invention, with its groove-like friction surface, fulfills a dual function: it converts the radial force directly over a short, fixed path into the axial force corresponding to the frictional force, so that a simple proportional correlation is produced between the radial force applied and the axial force to be controlled via the coefficient of friction between the friction surface and the strand. This allows for quick and accurate control. Secondly, the cylinder-casing-shaped geometry of the friction surface results in surface contact with the strand. This reduces the pressure between the friction surface and the strand, and therefore mechanical damage to the periphery of the extrudate is avoided. In addition, the surface contact makes it possible for heat to flow from the strand into the brake block, and the latter—dimensioned in an accordingly bulky manner—serves as a heat sink. Overheating of the friction surface is thereby precluded, and therefore it can also be operated at higher temperatures.

The embodiment according to the invention of the brake device therefore achieves two technically very different objects with respect to the prior art.

A preferred development of the invention consists in the fact that, in addition to the first, movable brake block, the brake device comprises a second, radially fixed brake block provided with a counter-friction surface, wherein the counter-friction surface has the shape of a groove-like section of a cylinder casing. The basic principle of this development is to move the movable brake block against an immovable block. Compared to two brake blocks which move in relation to one another, this embodiment has the advantage that the radial force can be determined more accurately via the position of the block, since the present position of a movable counter-block does not have to be taken into consideration. This proves advantageous for the quality of control.

The brake device is preferably shaped such that the friction surface and the counter-friction surface complement one another in an end position of the radially movably guided brake block to form a cylinder casing which encompasses the strand of plastic. In this way, the radial force is introduced into the strand via a particularly small surface pressure, and therefore the calibrated shape of the latter remains unchanged.

In principle, the invention is not restricted to circular-cylindrical shapes: thus, it is also possible to extrude semi-finished products having an elliptical or polygonal cross section which, in mathematical terms, have a general cylinder shape. The shape of the friction surfaces according to the invention can accordingly also be correspondingly elliptical or polygonal. However, all of said cylinders are preferably circular cylinders.

In the case of the circular-cylindrical shape, it is advantageous if the radius of the friction surface and/or of the counter-friction surface is smaller than half the outer diameter given to the strand of plastic by the calibration unit. As a result of a minimum undersize, the axial force is introduced into the strand in a particularly uniform manner while preserving the surface.

The friction surfaces preferably consist of copper-containing materials such as yellow brass, red brass or bronze. These non-ferrous materials provide good heat dissipation, and therefore it is possible to extrude plastics with high processing temperatures on the system, such as preferably polyether ether ketone.

The extrusion system according to the invention is preferably equipped with pneumatics which can act upon the radially movably guided brake block in the direction of the strand of plastic. The pneumatics allow for high control dynamics, since pneumatic cylinders can apply a rapidly rising or falling pressure to, or relieve the latter from, the radially movably guided brake block.

Advantageously, the brake device is arranged on the carriage of a linear guide extending parallel to the strand of plastic, and is therefore mounted axially displaceably, and the force transducer is arranged between the carriage and the immovable frame of the extrusion system. This configuration ensures that the force transducer is always loaded parallel to the axial force and that, on account of the low frictional losses within the linear guide, the force measured in the force transducer corresponds to the axial force to the greatest possible extent. This therefore provides good measured values, which are a prerequisite for a high quality of control.

The force transducer used is preferably a pressure-loaded load cell which, as seen in the direction of advance of the strand of plastic, is arranged on the end of the carriage, facing toward a stop located on the frame of the extrusion system. This configuration has proved to be particularly feasible during operation and during retrofitting of the extrusion system on other extrusion dies.

The back pressure in the strand of plastic is preferably retained constantly by a control circuit, within which the axial force represents the controlled variable and the radial force represents the manipulated variable. Specifically, the radial force can be set considerably more dynamically on account of the brake device, such that the brake device allows for significantly better control than is the case for known control concepts, in which the manipulated variable used for keeping the back pressure constant is the rotational speed of the screw or the speed of a take-off system.

The control circuit preferably has a controller with combined proportional, differential and integral control characteristics (PID). Experiments show that a PID controller best achieves the present control object.

The extrusion system according to the invention is outstandingly suitable for producing cylindrical semi-finished products made of heat-resistant plastic and in particular for producing circular-cylindrical solid rods made of polyether ether ketone. These uses therefore likewise form part of the subject matter of the invention.

The invention will now be explained in more detail on the basis of an exemplary embodiment and with reference to the accompanying figures:

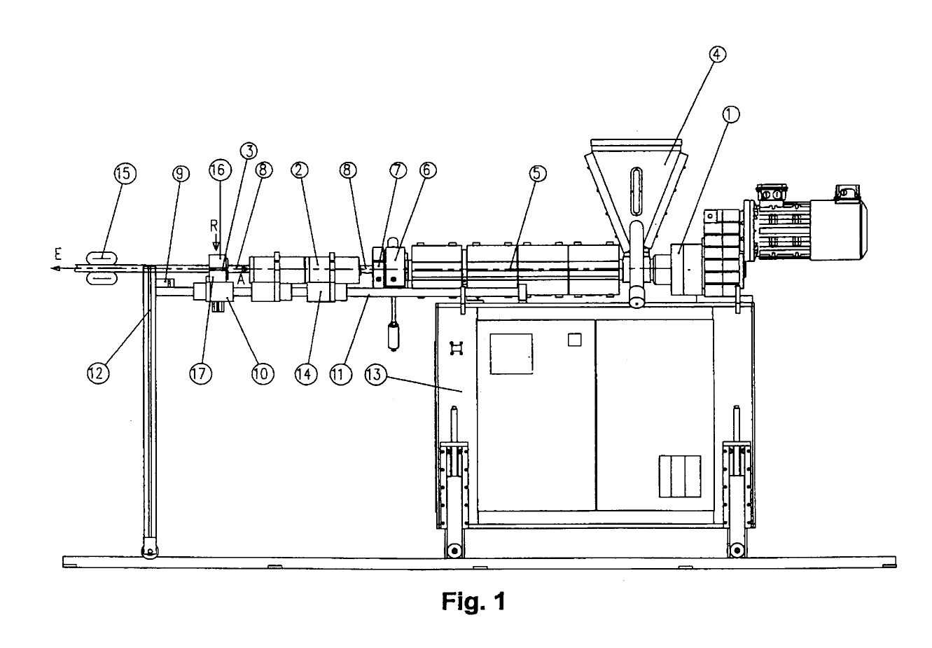

FIG. 1: is a schematic illustration of the extrusion system in a side view;

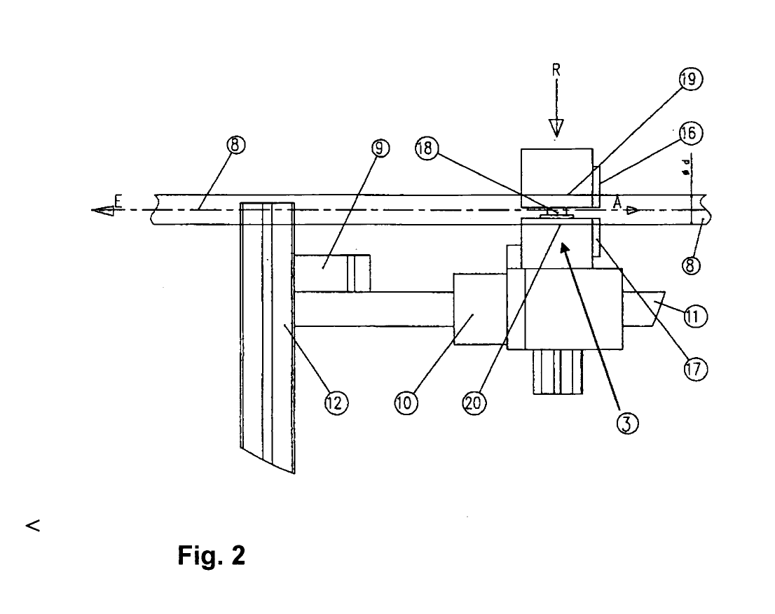

FIG. 2: shows an enlargement from FIG. 1 in the region of the brake device;

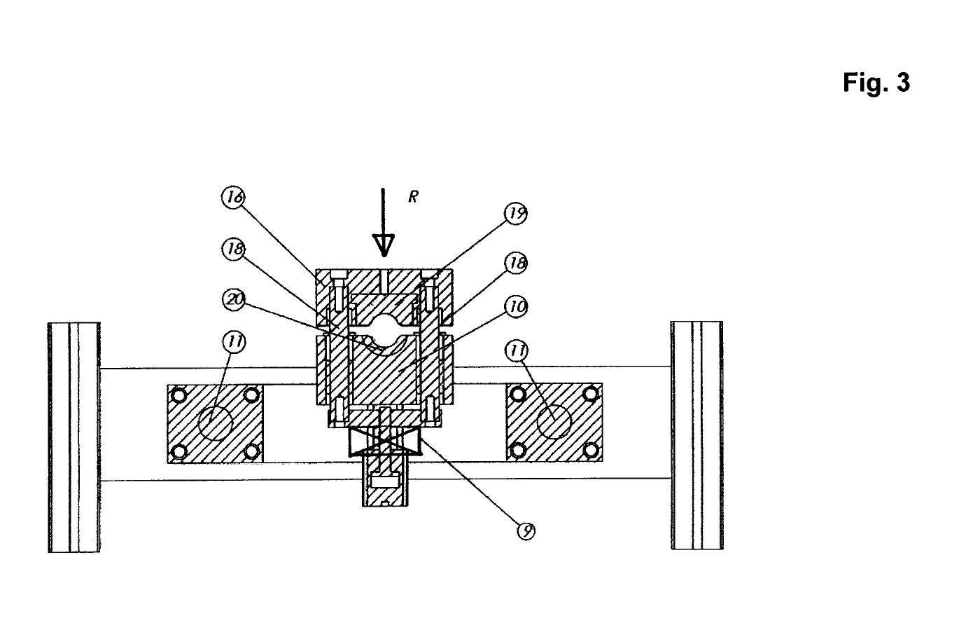

FIG. 3: is a view from the front of the brake device; and

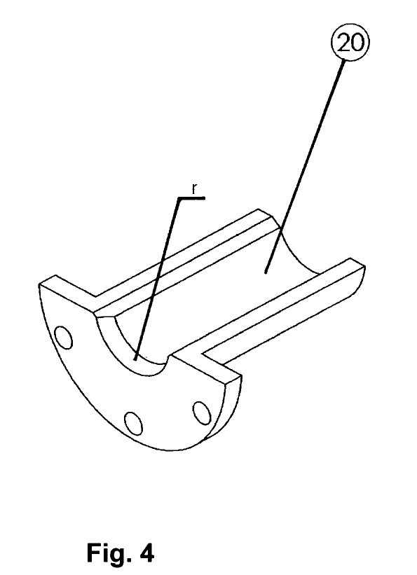

FIG. 4: is a perspective illustration of the counter-friction surface.

In relation to FIG. 1: the extrusion system according to the invention comprises, inter alia, an extruder 1, a calibration unit 2 and a brake device 3. These subassemblies are arranged coaxially along the linear extrusion direction E. The extruder 1 is a screw extruder, a machine known for the processing of thermoplastic materials. The extruder receives the raw thermoplastic material in the form of granules in a funnel 4. The extruder 1 is provided with a screw 5, which is surrounded by a heating unit and conveys the granules in the extrusion direction E under the action of heat and applies pressure thereto. A storage chamber 6, in which the plastic is present in a pressure-loaded melt, is located downstream of the screw 5. The temperature during the extrusion of the high-temperature-resistant thermoplastic polyether ether ketone is here about 400° C., and the optimum back pressure during the extrusion of solid PEEK rods is about 5 bar.

Downstream, the storage chamber 6 is delimited by an extrusion die 7 known per se. This has a circular opening from which the melt exits as a circular-cylindrical, continuous strand of plastic 8. It is also possible to use other die forms on the system, for example elliptical or polygonal cross sections. In mathematical terms, such extrudate forms are likewise cylinders. Therefore, the invention is not restricted to circular-cylindrical forms. A system according to the invention can also comprise an extrusion die with a plurality of openings, so that a plurality of parallel extrusion strands issue therefrom. The system parts described below would then accordingly be present in a large number and be arranged parallel to one another. For the sake of simplicity, an extrusion system comprising a single strand of plastic 8 extruded in extrusion direction E is described.

The freshly extruded strand of plastic 8 preformed by the opening in the extrusion die 7 firstly enters the calibration unit 2. In simplified terms, the calibration unit, known per se, is a cylindrical, cooled pipe with a defined inner diameter. The inner diameter of the pipe is given to the strand of plastic 8 as the outer diameter d. In the process, the strand of plastic 8 is cooled so that the melt solidifies. When it leaves the calibration unit 2, the temperature of the strand of PEEK plastic is about 100° C.

The brake device 3 is connected downstream of the calibration unit 2. The brake device 3 has the function of variably introducing an axial force A, which is directed opposite to the extrusion direction E or the advance of the strand of plastic 8, into the strand of plastic 8. This axial force A is able to increase the pressure within the strand of plastic 8 between its exit from the extrusion die 7 and the brake device 3, i.e. in particular in the region of the cooling calibration unit. The pressure within this portion of the strand of plastic 8 has a considerable influence on the dimensional stability of the extrudate: since thermoplastic materials shrink during cooling, it is necessary to specify enough material to compensate for the degree of shrinkage. A high dimensional stability and material density is therefore determined via the correct back pressure in the region of the calibration unit 2, which, according to the invention, is set via the axial force A produced by the brake device 3. The mode of operation of the brake device 3 is explained below.

The axial force A introduced into the strand of plastic 8 by the brake device 3 is measured with the aid of a force transducer 9 in the form of a pressure-loaded load cell. For this purpose, the brake device 3 is arranged on the carriage 10 of a linear guide 11 extending parallel to the extrusion direction E or to the strand of plastic 8, such that the brake device 3 is axially freely displaceable. In the extrusion direction E, the mobility of the carriage 10 is limited by a stop 12, which is part of the immovable frame 13 of the extrusion system. The end of the carriage 10 is provided with the load cell 9, with which the carriage 10 bears with loading against the stop 12. As soon as the brake device 3 introduces an axial force A into the strand 8 advancing in the extrusion direction E, the carriage 10 is carried along until it rests against the stop by way of the load cell 9. On account of the parallel orientation of the linear guide 11 in relation to the extrusion direction E, the force measured in the load cell 9 wedged in between the stop 12 and the carriage 10 is oriented parallel to the axial force A. Since the friction within the linear guide 11 is very low, the force measured in the load cell 9 corresponds approximately to the axial force A. The force transducer 9 therefore supplies a measured value which corresponds outstandingly to the magnitude of the axial force A to be measured.

With respect to the overall structure of the extrusion system, it remains to be mentioned that the calibration unit 2 is likewise guided axially displaceably relative to the strand 8 by means of a second carriage 14 on the linear guide 11, and the linear guide 11 is mounted directly in the extrusion die 7 on the extruder side. This achieves a high coaxiality of the extrusion die 7, the calibration unit 2 and the brake device 3, as a result of which the strand of plastic 8 can be produced with small dimensional tolerances. A roller take-off 15 which is known per se and synchronized with the advance of the strand of plastic 8 is arranged downstream of the brake device 3. Further system parts such as a cooling and/or vacuum section or an apparatus for cutting to length may be arranged downstream thereof. Since such devices are generally known in extrusion systems, they do not require further explanation here.

The structure and the mode of operation of the brake device 3 will now be explained with reference to FIGS. 2 and 3: the brake device 3, through which the strand of plastic 8 passes, comprises two brake blocks 16, 17. The first brake block 16 is guided radially movably relative to the strand of plastic 8, whereas the second brake block 17 is radially immovable. The radial mobility of the brake block 16 relative to the fixed brake block 17 is ensured via a radial guide 18, which is fixed in the radially immovable brake block 17 and on which the radially movable brake block 16 slides. The position of the movable brake block 16 in relation to the fixed brake block 17 is set by pneumatics (not shown) comprising an actuator which can be used to displace the movable brake block 16. The assembly of the two brake blocks 16, 17 is axially displaceable as a whole relative to the strand of plastic 8, since the radially fixed brake block 17 rests directly on the carriage 10 of the linear guide 11.

Both brake blocks 16, 17 have a friction surface 19 or a counter-friction surface 20 on that side which faces toward the strand of plastic 8. The friction surfaces 19, 20 in the brake blocks 16, 17 are each formed by a yellow brass insert, which has the shape of a groove-like section of a cylinder casing. This shape is obtained by bisecting a cylindrical, thin-walled pipe in the longitudinal direction. FIG. 4 is a perspective illustration of the yellow brass insert, the inner wall of which forms the counter-friction surface 20 in the form of a casing of a circular cylinder. The radius r of the two friction surfaces 19, 20 is the same and slightly smaller than half the diameter d of the outer diameter of the strand of plastic 8 given to the latter by the calibration unit 2. The movable brake block 16 can be displaced as far as into an end position against the immovable brake block 17, in which the two friction surfaces 19, 20 complement one another to form a cylinder casing which encompasses the strand of plastic 8. On account of the small undersize of the friction surfaces 19, 20, surface contact occurs between the brake blocks 16, 17 and the strand of plastic 8, and therefore the surface pressure is small. The undue introduction of stresses into the extrudate is therefore avoided. Minor damage to the strand is harmless since the semi-finished product is also machined further anyway.

The optimum back pressure of about 5 bar within the cooling extrudate is set via the axial force A which the brake device 3 introduces into the strand of plastic 8. For this purpose, the actuator of the pneumatics applies a radial force R which can act in the direction of the fixed brake block 17 to the movable brake block 16. In this case, the strand 8 is pressed between the friction surface 19 and the counter-friction surface 20, so that a frictional force proportional to the radial force R is produced at the friction surfaces 19, 20, said frictional force resulting as the axial force A directed opposite to the advance of the strand of plastic 8. The air pressure in the pneumatic actuator controls the radial force R such that the magnitude of the axial force A can be varied by means of the brake device 3. As already described, the axial force A is measured very accurately using the load cell 9.

A control circuit (not shown) keeps the axial force A and therefore the back pressure in the strand of plastic 8 constant. To that end, the control circuit receives the axial force actual value measured by the force transducer 9, constantly compares it with a preset axial force setpoint value and correspondingly sets the radial force R via the pneumatics, in order to match the axial force actual value to the axial force setpoint value. If the axial force is too low, the radial force R is increased by stronger attraction of the movable brake block 16; if the back pressure in the extrudate is too high, the air pressure in the actuator is reduced. Therefore, within the control circuit the axial force A represents the controlled variable X, whereas the radial force R functions as the manipulated variable Y. The control is performed by a PID controller. The adjustment of the radial force R takes place considerably more dynamically than the adjustment of the rotational speed of the screw or the alteration of an imprinted take-off speed, which are both control operations conventional in the prior art. Nevertheless, the control according to the invention via the radial force R can be combined with the conventional control via the rotational speed of the screw and the take-off speed as manipulated variables.

### LIST OF REFERENCE SYMBOLS

1 Extruder
2 Calibration unit
3 Brake device
4 Funnel
5 Screw
6 Storage chamber
7 Extrusion die
8 Strand of plastic
9 Load cell as force transducer
10 Carriage
11 Linear guide
12 Stop
13 Frame
14 Carriage of the calibration unit
15 Roller take-off
16 Radially movable brake block
17 Radially fixed brake block
18 Radial guide
19 Friction surface
20 Counter-friction surface
E Extrusion direction
A Axial force
R Radial force
r Radius of the friction surfaces
d Diameter of the strand of plastic

1. An extrusion system comprising:
a) an extruder which provides a pressurized melt of a plastic;
b) at least one extrusion die which is arranged on the extruder and through which the melt leaves the extruder as a substantially cylindrical strand of plastic;
c) a calibration unit which is arranged downstream of the extrusion die and through which a freshly extruded strand of plastic passes, said calibration unit cooling the strand of plastic and giving it an outer diameter (d);
d) a brake device which is arranged downstream of the calibration unit and which makes it possible to variably introduce an axial force (A) into the strand of plastic, the axial force being directed opposite to a direction of advance of the strand of plastic; and
e) a force transducer which measures the axial force (A) introduced into the strand of plastic by the brake device, wherein
f) the brake device comprises at least one radially movably guided brake block which is movably guided radially relative to the strand of plastic and comprises a friction surface,
g) a radial force (R) can be applied to the radially movably guided brake block when the friction surface of the brake block rests on a periphery of the strand of plastic in order to introduce the axial force (A) into the strand of plastic,
h) the friction surface has the shape of a groove section of a cylinder casing; and
i) wherein the extension system is suitable for producing a cylindrical semi-finished plastic product.

2. The system of claim 1, wherein the brake device comprises a radially fixed brake block with comprising a counter-friction surface, wherein the counter-friction surface has the shape of a groove section of a cylinder casing.

3. The system of claim 2, wherein the friction surface and the counter-friction surface complement one another in an end position of the radially movably guided brake block to form a cylinder casing which encompasses the strand of plastic.

4. The system of claim 1, wherein cylinders of the cylinder casing are circular cylinders.

5. The system of claim 4, wherein a radius (r) of at least one selected from the group consisting of the friction surface and of the counter-friction surface, is smaller than half the outer diameter (d) given to the strand of plastic by the calibration unit.

6. The extrusion system of claim 1, wherein at least one selected from the group consisting of the friction surface and the counter-friction surface comprises copper.

7. The system of claim 6, wherein at least one selected from the group consisting of the friction surface and the counter-friction surface, comprises yellow brass.

8. The extrusion system of claim 1 wherein the plastic is polyether ether ketone (PEEK).

9. The system of claim 1, having pneumatics which can act upon the radially movably guided brake block in the direction of the strand of plastic.

10. The extrusion system of claim 1, wherein the brake device is arranged on the carriage of a linear guide extending parallel to the strand of plastic, and is therefore mounted axially displaceably, and
wherein the force transducer is arranged between the carriage and the immovable frame of the extrusion system.

11. The system of claim 10, wherein the force transducer is a pressure-loaded load cell which, as seen in the direction of advance of the strand of plastic, is arranged on an end of the carriage, facing toward a stop located on a frame of the extrusion system.

12. The system of claim 1, further comprising a control circuit, within which the axial force (A) represents a controlled variable (X) and the radial force (R) represents a manipulated variable (Y).

13. The system of claim 12, wherein the control circuit comprises a controller with PID characteristics.

14. A heat-resistant plastic, produced with the extrusion system cylindrical semi-finished product, comprising heat-resistant plastic, produced by the extrusion system of claim 1.

15. The product of claim 14 wherein the heat-resistant plastic comprises polyether ether ketone.

16. The system of claim 1, wherein the friction surface and the counter-friction surface comprise copper.

17. The system of claim 2, wherein the friction surface and the counter-friction surface comprise copper.

18. The system of claim 1, wherein the friction surface and the counter-friction surface comprise yellow brass.

19. The system of claim 6, wherein at least one selected from the group consisting of the friction surface and the counter-friction surface, consists of yellow brass.

20. The system of claim 6, wherein the friction surface and the counter-friction surface consist of yellow brass.
